(19) United States
(12) Patent Application Publication
(10) Pub. No.: US 2001/0025791 A1
(43) Pub. Date: Oct. 4, 2001

(54) Methods and devices for separation of biological molecules

(76) Inventors: Ehud M. Landau, Galveston, TX (US); Javier V. Navarro, Galveston, TX (US)

Correspondence Address: MUETING, RAASCH & GEBHARDT, P.A., P.O. BOX 581415, MINNEAPOLIS, MN, 55401, US

(21) Appl. No.: 09/739,524

(22) Filed: Dec. 15, 2000

Related U.S. Application Data
(60) Provisional application No. 60/170,890, filed on Dec. 15, 1999.

(51) Int. Cl. G01N 27/26; G01N 27/447

(52) U.S. Cl. 204/451; 204/450; 204/456; 204/469; 204/466; 204/600; 204/455; 204/601; 204/605; 204/606; 204/616

(57) ABSTRACT

The present invention provides methods for separating a compound, including a membrane polypeptide. The method includes the use of a bicontinuous lipidic phase. The invention also provides devices that include a bicontinuous lipidic cubic phase, and a kit for use in separating a compound, including a mixture that includes a lipid and an aqueous phase and instructions for using the mixture.

### CONTINUING APPLICATION DATA

This application claims the benefit of U.S. Provisional Application Ser. No. 60/170,890, filed Dec. 15, 1999, which is incorporated by reference herein.

### BACKGROUND

The ability to separate molecules plays a fundamental role in the biological sciences. Gel electrophoresis, one type of separation method, is often used because it is inexpensive and reproducible. In gel electrophoresis, a mixture of charged species is resolved into its components owing to different mobilities of these species in an imposed electric field. The mobilities largely depend on the gel used and on the characteristics of ions themselves, including net surface charge, size and shape. Gel electrophoresis is currently employed mostly for the separation of biological macromolecules, such as polypeptides, nucleic acids and their derivatives. The gels may be composed of natural or synthetic polymers. Regardless of the materials from which they are made, the polymers are present in an aqueous phase, and only molecules that are soluble in an aqueous phase, or have been treated so they are soluble in an aqueous phase, can be resolved.

Membrane polypeptides play key roles in a variety of cellular processes including energy and signal transduction. However, it is often difficult to separate or purify membrane polypeptides under conditions so they are still functional. Membrane polypeptides possess hydrophobic surfaces, which interact with the non-polar chains of lipids, and possess hydrophilic surfaces, which are exposed to the aqueous medium. As a result of having hydrophobic surfaces, membrane polypeptides are generally not soluble in an aqueous phase, and thus cannot be resolved by chromatographic procedures (e.g., gel electrophoresis) in an aqueous phase. Membrane polypeptides can be solubilized in detergents. This procedure yields detergent/polypeptide mixed micelles and renders membrane polypeptides water-soluble. These membrane polypeptides can be treated analogously to soluble polypeptides, e.g., resolved on a gel made up of a polymer in an aqueous phase. However, even though the introduction of detergents has led to substantial advances in the area of membrane polypeptide biochemistry, often there is substantial loss of activity by membrane polypeptides exposed to detergents.

### SUMMARY OF THE INVENTION

The present invention represents a significant advance in the art of separating compounds, including separating molecules or complexes of molecules, especially membrane polypeptides. A mixture of polypeptides from a cell includes polypeptides that are soluble in aqueous phase, and other polypeptides that are not. Prior to the present invention, the separation of cellular polypeptides often included mixing the polypeptides with a detergent to solubilize all polypeptides present; however, the presence of a detergent often causes some polypeptides, especially those having a hydrophobic surface (e.g., membrane polypeptides), to denature and/or aggregate and/or lose activity. The present invention describes a method of separating molecules, especially membrane polypeptides, using a lipidic cubic phase. Cubic phases have been used in the electrophoresis of nucleic acids, however, the cubic phases used were micellar (Rill et al., Proc. Natl. Acad. Sci. USA, 95, 1534-1539 (1998)). Micellar cubic phases can cause the denaturation of some polypeptides. The present invention makes use of bicontinuous lipidic cubic phases for the separation of, for instance, membrane polypeptides. Bicontinuous lipidic cubic phases typically do not cause the denaturation of polypeptides. The use of bicontinuous lipidic cubic phases provides conditions that solubilize polypeptides soluble in aqueous phase as well as those that are not soluble in aqueous phase, and greatly decreases denaturation, loss of activity, and/or formation of aggregates.

The invention provides a method for separating a compound, including contacting a mixture of at least two compounds with a bicontinuous lipidic cubic phase, and applying an external field for a period of time sufficient to result in sufficient movement of the compounds relative to each other such that a compound is separated from the mixture. Optionally, the compound can be isolated, or purified. Optionally, the compound can be removed from the lipidic cubic phase after separation. The compound that is separated can be a biological compound (e.g., obtained from a biological entity), including a membrane polypeptide. The external field can be an electrical gradient, including current or voltage. Optionally, the mixture can contain a detergent, and/or the lipidic cubic phase can contain a detergent before contacting. The lipidic cubic phase can include a monoacylglycerol, including, for instance, monoolein, monovaccenin, monopentadecenoin, monomyristolein, monoelaidin, monopalmitolein, or monoerucin.

The invention further provides a kit for use in separating a compound. The kit includes a mixture including a lipid(s) and an aqueous phase and instructions for using the mixture. The mixture is one that will form a bicontinuous lipidic cubic phase under specific conditions. The kit can further include a device suitable for use in an electrophoresis apparatus, including, for instance, a capillary tube or a plate. The lipid can be a monoacylglycerol, including, for instance, monoolein, monovaccenin, monopentadecenoin, monomyristolein, monoelaidin, monopalmitolein, or monoerucin.

The present invention also provides a device including a bicontinuous lipidic cubic phase, for instance a capillary tube or a plate, and an electrophoresis apparatus including a bicontinuous lipidic cubic phase.

Definitions

As used herein, the term “compound” refers to a molecule or a complex of molecules. A molecule is a group of covalently linked atoms. Examples of molecules include a polypeptide, for instance, cytochrome C. A complex of molecules is a group of at least two molecules that are bound together by at least one non-covalent force, including, for instance, hydrogen bond(s), Van der Walls forces, electrostatic interactions, and hydrophobic interactions. Examples of complexes of molecules include, for instance, an antibody bound to the antigen that induced the synthesis of the antibody, and a polynucleotide bound to a polypeptide. A compound can be synthesized by enzymatic or chemical methods, including, for instance, solid phase peptide synthesis. The term “biological compound” includes a compound that is obtained from a biological entity, including for instance, a cell or a virus. A biological compound can be naturally produced by a biological entity, or can be produced by, for instance, a recombinant polynucleotide present in a cell. Examples of cells include eukaryotic (i.e., with a nucleus) and prokaryotic (i.e., without a nucleus) cells. The term “biological compound” includes a compound that has been modified by, for instance, labeling with a molecule (e.g., rhodamine) while in the cell or after removal from the cell.

As used herein, the term “polynucleotide” refers to a polymeric form of nucleotides of any length, either ribonucleotides or deoxynucleotides, and includes both double- and single-stranded DNA and RNA.

As used herein, the term “polypeptide” refers to a polymer of amino acids and does not refer to a specific length of a polymer of amino acids. Thus, for example, the terms peptide, oligopeptide, protein, and enzyme are included within the definition of polypeptide. This term also includes post-expression modifications of the polypeptide, for example, glycosylations, acetylations, phosphorylations and the like.

A “separated” compound means a compound that has migrated through a lipidic cubic phase (LCP) of the present invention such that at least a portion of it can be distinguished from other compounds in the LCP that migrate at different rates, and are accordingly present at other locations within the LCP. An “isolated” compound means a compound that is essentially free from other compounds. The term “isolated” encompasses preparations of a compound, including a compound present in an LCP, having less than about 5% (by weight) of contaminating compound. Such a contaminating compound is one that co-migrates with the “isolated” compound. Preferably, a compound is purified, i.e., having less than about 1% (by weight) of contaminating compound.

As used herein, the phrase “lipidic cubic phase” refers to a material that is composed of a lipid and an aqueous phase, for instance water, and that exhibits the structural and dynamic properties of a cubic phase. The properties of lipidic cubic phases are described in greater detail herein. As used herein, the term “lipid” refers to a hydrophobic or amphiphilic molecule that is not water soluble, or slightly water soluble, and will form a lipidic cubic phase as described herein. A lipid can be natural (i.e., it is present in or produced by nature) or synthetic (i.e., it is artificial or man-made).

The term “monoacylglycerol” as used herein refers to a type of lipid, and is described in greater detail herein.

As used herein, a “membrane polypeptide” is a polypeptide having a surface that includes a region of hydrophobic amino acids. A membrane polypeptide is present in a biological entity and is associated with a lipid bilayer present in the biological entity. The association can be such that the membrane polypeptide is present in and surrounded by the lipid bilayer. Alternatively, a membrane polypeptide can be inserted in the lipid bilayer such that a portion of the surface of the polypeptide is exposed to the hydrophobic environment present in a lipid bilayer and a portion of the polypeptide is exposed to the hydrophilic environment present either outside the cell or in the cytoplasm of a cell.

As used herein, the phrase “external field” refers to an external vector quantity that can cause movement of a molecule in the direction of its application. An example of an external field includes, for instance, an electrical gradient (e.g., current or voltage), centrifugal force, hydrostatic pressure, electrostatic attraction, electrostatic repulsion, or a magnetic field.

As used herein, a “detergent” refers to a type of molecule that is able to form micelles in an aqueous solution above a critical concentration and at a temperature range which varies depending on the detergent. As used herein, a “detergent” in solution also has the characteristic of being a free flowing liquid when micelles are present.

As used herein, an “electrophoresis unit” is a machine that can be used in the electrophoretic separation of compounds.

Unless otherwise specified, “a,” “an,” “the,” and “at least one” are used interchangeably and mean one or more than one.

### BRIEF DESCRIPTION OF THE FIGURES

FIG. 1. Schematic representation of a bicontinuous lipidic cubic phase.

FIG. 2. Temperature-composition phase diagram of monoolein. The components are water and monoolein, thus, at a water concentration of 40% (w/w), the concentration of monoolein is 60% (w/w). Each line represents a boundary between two distinct phases. Those regions of the diagram showing the presence of a lipidic cubic phase are those that include Ia3d and/or Pn3m. FI, fluid isotropic phase; Lα, lamellar liquid crystalline phase; Ia3d, lipidic cubic phase of crystallographic space group Ia3d with G surface; Pn3m, lipidic cubic phase of crystallographic space group Pn3m with D surface; and Lc, lamellar crystalline phase; Pn3m+water, the lipidic cubic phase with D surface is present in an excess of water. A phase that lists two terms, for instance, Pn3m+Ia3d, indicates that both types of phases are present. A G surface is a specific infinitely periodic minimal surface often referred to as a “gyroid”; a D surface is a specific infinitely periodic minimal surface often referred to as a “diamond”.

### DETAILED DESCRIPTION OF THE INVENTION

The present invention provides for a lipidic cubic phase (LCP) that can be used for the separation, preferably isolation, more preferably purification, of a compound. An LCP is a material that, under certain conditions, displays cubic symmetry. An LCP includes a lipid, preferably a monoacylglycerol, and an aqueous phase.

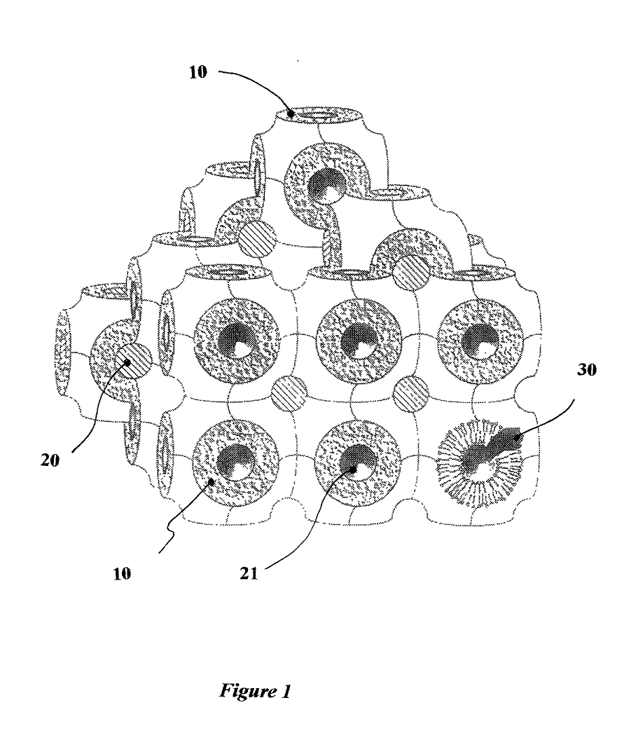

Cubic phases can be divided into two different groups (see, e.g., Lindblom and Rilfors, Biochim. Biophys. Acta, 988, 221-256 (1989)). One group has cubic structures built up with either discontinuous lipid regions and continuous aqueous regions (e.g., micellar aggregates in water), or with discontinuous aqueous regions and continuous lipid regions (e.g., reversed micellar aggregates in a nonpolar solvent). The second group has cubic structures having regions which are continuous with respect to both aqueous and lipid compartments. LCPs in this group are referred to as bicontinuous. An LCP of the present invention is bicontinuous. Unless otherwise noted, the term “LCP” as used herein refers to a bicontinuous LCP. A schematic diagram of a bicontinuous LCP is shown in FIG. 1. Two unconnected aqueous channel systems, each following a cubic lattice, are separated by a single lipid bilayer (10) following a infinitely periodic minimal surface. An infinitely periodic minimal surface is a term that is known to the art and described in Lindblom and Rilfors (Biochim. Biophys. Acta, 988, 221-256 (1989)). These two unconnected aqueous channel systems are marked as either hatched circles (20) or shaded circles (21). Although solutes can freely diffuse within each of the two aqueous compartments, solutes cannot get from one to the other channel system without traversing the bilayer. Lipids or amphiphiles can diffuse freely within the bilayer and will, unless they flip from one leaflet of the bilayer to the other, always face the same aqueous compartment. In the lower right corner, one membrane protein (30) is drawn residing in the bilayer.

One lipid, preferably at least two lipids, can be used to make an LCP. Preferably, the lipid is a monoacylglycerol. Examples of useful lipids, including monoacylglycerols, can be found in Lindblom and Rilfors, (Biochim. Biophys. Acta, 988, 221-256 (1989)), and include, for example, monoolein, monovaccenin, monopentadecenoin, monomyristolein, monoelaidin, monopalmitolein, and monoerucin. Preferably, the monoacylglycerol is monoolein.

The aqueous phase that is used to make an LCP includes water. An example of a useful aqueous phase is 1×native running buffer, as described in the Examples. Preferably, when an LCP is to be used in the separation of compounds that are obtained from a cell, the aqueous phase includes components that will aid in keeping compounds in their native conformation (e.g., the conformation the compounds have when in the cell). Such components can include hydrogen ions, salt ions, buffers, and glycerol. A person of skill in the art will recognize that the inclusion of one or more of these components can have an effect on the phase behavior of an LCP in general, and on the ability of an LCP to form. Accordingly, the compound that is to be present in the LCP when separating, preferably isolating, a compound should be included when determining the conditions to form an LCP. Methods for determining such conditions are described herein.

The pH of an aqueous phase can be about pH 1.0 to about pH 14.0, more preferably about pH 4.0 to about pH 9.0. Typically, when the lipid used to make the LCP is charged, the pH can affect the ability of an LCP to form. The salts that can be used include physiologically relevant salts, e.g., MgCl₂, CaCl₂, NaCl, KCl, and phosphate salts. The buffers that can be used include those known to the art as buffers that can be used with biological entities, for instance 3-([3-cholamidopropyl]dimethylammonio)-1-propanesulfonate (CHAPS), N-(2-hydroxyethyl)piperazine-N′-(2-ethanesulfonic acid) (HEPES), 3-(N-morpholino)propanesulfonic acid (MOPS), piperazine-N,N′-bis(2-ethanesulfonic acid)1,4-piperazinediethanesulfonic acid (PIPES). Glycerol can be used at a concentration of about 1% to about 30% (weight/weight), preferably about 1% to about 5%.

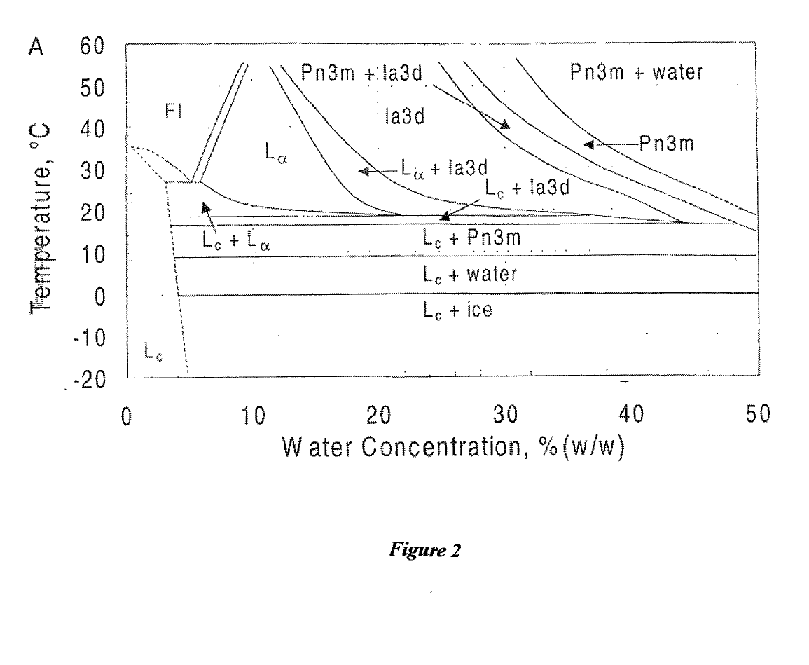

An LCP is made by simply mixing a specific amount of a lipid(s), preferably a monoacylglycerol, and an aqueous phase together under specific conditions. The conditions that can be important when making an LCP include temperature, pressure, salt concentration, pH, water concentration, lipid concentration, and the concentration of added components. The conditions that are suitable for formation of an LCP by one lipid are not necessarily the conditions that will be suitable for formation of an LCP with a different lipid, but are easily determined by assaying for the presence of an LCP as the conditions are changed. Typically, one condition is varied while all other conditions are held constant, and the presence of an LCP is assayed. An example is shown in FIG. 2, which depicts the phase transitions of monoolein in water as a function of temperature and concentration.

When an LCP is formed using a lipid(s) and an aqueous solution, and optionally other components, the LCP has three characteristics: it is transparent, non-birefringent, and a semi-solid. When the same mixture of components is not an LCP, it lacks at least one of the above characteristics. These characteristics can be measured by methods known to the art. When a solution containing a lipid(s) and an aqueous phase undergoes a phase transition and becomes an LCP, the solution becomes a transparent, non-birefrengent semi-solid. The transparency of a solution can be measured at a wavelength of visible light (about 400 nm to about 750 nm). At such a wavelength, as a solution transitions from a non-LCP to an LCP, the optical density typically decreases to less than 0.1 optical density units.

When a mixture containing a lipid(s) and an aqueous phase undergoes a phase transition and becomes an LCP, the mixture changes from being birefringent to being non-birefringent. The birefringency of a solution can be measured by methods known to the art, including inspection under an optical microscope with cross polarizers. Birefringent patterns will clearly show up upon rotating one of the polarizers, whereas non-birefringent materials will show an absence of birefringent patterns.

When a mixture containing a lipid(s) and an aqueous phase undergoes a phase transition and becomes an LCP, the mixture changes from being a free flowing liquid to being a semi-solid. A material is a semi-solid if it does not flow under a gravitational field, and, when prepared or put in a thin glass capillary, does not wet the glass surface to form a meniscus (i.e., it exhibits a flat surface). It is, however, a soft solid material (therefore semi-solid), which means that its macroscopic shape and form can be affected by mechanical means. One can measure the Theological (viscoelastic) properties of such materials, for instance by applying shear forces and measuring the response. The measurements of rheological properties is known to the art. The viscosity of an LCP is greater than that of a liquid, but less than that of a solid.

As shown in FIG. 2, there are at least 4 different areas for a monoolein-water mixture that are a bicontinuous LCP; Ia3d, Pn3m+Ia3d, Pn3m, and Pn3m+water. Typically, either one of these conditions can be used in the methods of the invention. The Pn3m+water phase is a phase where water is in excess. It will be noted by a person of skill in the art that when the methods involve electrophoresis, or other methods where water is in excess, regardless of which phase is initially used, e.g., Ia3d, Pn3m+Ia3d, or Pn3m, the excess of water will cause the phase to transition to the Pn3m+water phase. In other words, when the specific conditions for LCP formation by a lipid(s), preferably a monoacylglycerol, are determined, the LCP can be used in conditions where water is in excess and the LCP will be maintained. The conditions for forming a bicontinuous LCP for some lipids are described in Lindblom and Rilfors (Biochim. Biophys. Acta, 988, 221-256 (1989)).

Methods for distinguishing a bicontinuous LCP from other types of LCPs are known to the art. Such methods include diffusion measurements obtained by nuclear magnetic resonance, and measurements of phase structure by x-ray scattering or diffraction, or by transmission electron microscopy (see, e.g., Lindblom and Rilfors, Biochim. Biophys. Acta, 988, 221-256 (1989)).

The % weight of the lipid(s) in the LCP, and the type of lipid(s) used as well as the temperature influences the ability of the LCP to separate compounds. For instance, a certain % weight of a lipid will cause resolution of compounds having a molecular weight below 100 kiloDaltons (kDa), while a different % weight will cause resolution of compounds having a molecular weight above 100 kDa. Also, different lipids will also influence the ability of the LCP to resolve compounds of different molecular weights. Which conditions are best suited for separating a particular compound can be easily determined by optimizing the conditions used to make the LCP and by testing different lipids.

The LCP can be made in, or transferred to, a device for holding the LCP while an external field is applied and a compound separated. Examples of devices that can be used when the external field is an electrical gradient include, for instance, a tube or plate (e.g., for use as a slab gel) that can be used for electrophoresis in an electrophoresis apparatus. In electrophoresis, a buffer-filled tube or plate is suspended between two reservoirs filled with buffer. An electric field is applied across the two ends of the capillary. Samples containing a mixture of compounds are typically introduced at the high potential end. The samples migrate toward the low potential end. During the migration, compounds in the mixture are electrophoretically separated. After separation, the components are detected. Detection may occur while the compounds are still in the tube or plate, or after they have been removed. Methods of detection are known to the art, and include, for instance, spectrophotometric detection, fluorescence, and staining with, for instance, coomasie blue.

When an LCP is to be used in electrophoresis, the aqueous phase is typically selected so that it is an electrolyte which contains both anionic and cationic species. Examples of an electrolyte for a typical electrophoresis system include mixtures of water with organic solvents and salts. Representative materials that can be mixed with water to produce appropriate electrolytes includes inorganic salts such as phosphates, bicarbonates and borates; organic acids such as acetic acids, propionic acids, citric acids, chloroacetic acids and their corresponding salts and the like; alkyl amines such as methyl amines; alcohols such as ethanol, methanol, and propanol; polyols such as alkane diols; nitrogen containing solvents such as acetonitrile, pyridine, and the like; ketones such as acetone and methyl ethyl ketone; and alkyl amides such as dimethyl formamide, N-methyl and N-ethyl formamide, and the like. The above ionic and electrolyte species are given for illustrative purposes only. A person skilled in the art is able to formulate electrolytes from the above-mentioned species, to produce suitable support electrolytes for using electrophoresis systems. The voltage used for electrophoretic separations is not critical to the invention, and may very widely.

Electrophoresis apparatuses that can be used are known to the art (see, e.g., U.S. Pat. No. 4,048,049 (Hoefer), and U.S. Pat. No. 6,110,340 (Lau et al.)). The use of a capillary tube in such a format is described in the Examples. The electrophoresis can be analytical or preparative. Capillary tubes having internal diameters of, for instance, from about 5 millimeters to about 10 millimeters can also be used for analytical electrophoresis. Other devices that can be used to hold the LCP include tubes that can be used for centrifugation when the external field is centrifugal force.

The mixtures of compounds that contain a compound to be separated, preferably isolated, can be obtained from a biological entity, including a cell or a virus. A cell or a virus can be combined with a mixture of a lipid(s) and an aqueous phase and mixed to form a bicontinuous LCP. Optionally and preferably, a cell can be broken open using methods that are known to the art, and then combined with a mixture of a lipid(s) and an aqueous phase and mixed to form a bicontinuous LCP. The LCP would contain soluble polypeptides present in the aqueous phase of the LCP, and membrane polypeptides present in the lipid phase of the LCP. This LCP can be added to an LCP that is present in, for instance, a capillary tube. Optionally, before adding to an LCP in a capillary tube, insoluble material could be removed by briefly spinning the LCP in a centrifuge.

Preferably, a cell would be subjected to sub-cellular fractionation, and the appropriate fraction combined with a lipid, and optionally an aqueous phase, under conditions suitable for formation of an LCP. Methods of sub-cellular fractionation are known to the art (see, e.g., Evans, “Preparation and characterization of mammalian plasma membranes.” In: Laboratory Techniques in Biochemistry and Molecular biology, Work et al. (eds.), North-Holland Publishing, New York (1980)). Preferably, when the compounds that are to be separated include a membrane polypeptide, the solutions used during sub-cellular fractionation do not include a detergent.

Typically, sub-cellular fractionation includes breaking open cells by, for instance, sonication, mechanical homogenization, or french press. When the compounds that are to be separated using the methods of the present invention are soluble polypeptides, for instance polypeptides present in the cytoplasm of a cell, the soluble polypeptides can be concentrated by various methods known to the art, including, for instance, ultrafiltration. The concentrated soluble polypeptides can then be combined with a lipid, or a mixture of lipid and aqueous phase, to form an LCP which can then be added to an LCP present in, for instance, a capillary tube. Alternatively, the concentrated soluble polypeptides can be added directly to an LCP present in, for instance, a capillary tube.

When the compounds that are to be separated using the methods of the present invention are membrane polypeptides, the mixture resulting from breaking open the cells can be subjected to differential centrifugation, which separates compounds by density. The result of differential centrifugation is a series of bands having different densities. Each band contains a mixture of lipids and polypeptides associated with the lipids. After differential centrifugation, these bands can be removed from the apparatus (e.g., a tube) used for the differential centrifugation, and further concentrated by centrifugation under conditions such that a pellet is formed. The pellet that results from the centrifugation can be suspended in a buffer and then combined with a lipid(s), or a mixture of a lipid(s) and aqueous phase, to form an LCP which can them be added to an LCP present in, for instance, a capillary tube. Alternatively, the concentrated soluble polypeptides can be added directly to an LCP present in, for instance, a capillary tube.

Compounds, preferably membrane polypeptides, that have been separated, preferably isolated, using the methods of the invention can be used in, for instance, functional studies, microsequencing, forming 2-dimensional or 3-dimensional crystals.

The present invention also provides a kit for separating a compound. The kit includes a mixture including a lipid(s) and an aqueous phase, wherein the mixture will form a bicontinuous lipidic cubic phase under specific conditions, in a suitable packaging material in an amount sufficient for at least one separation. Optionally, other reagents needed to practice the invention are also included, such as buffers, solutions, and/or a device for holding the LCP while an external field is applied and a compound separated. Instructions for use of the packaged mixture comprising a lipid and an aqueous phase are also typically included.

As used herein, the phrase “packaging material” refers to one or more physical structures used to house the contents of the kit. The packaging material is constructed by known methods, preferably to provide a sterile, contaminant-free environment. The packaging material has a label which indicates that the mixture comprising a lipid and an aqueous phase can be used for separating a compound. In addition, the packaging material contains instructions indicating how the materials within the kit are employed to separate a compound. As used herein, the term “package” refers to a solid matrix or material such as glass, plastic, paper, foil, and the like, capable of holding within fixed limits a mixture comprising a lipid and an aqueous phase. Thus, for example, a package can be a glass vial used to contain a appropriate quantity of a mixture comprising a lipid and an aqueous phase, or it can be a capillary tube to which a LCP has been added. “Instructions for use” typically include a tangible expression describing at least one method parameter to use for separation.

The present invention is illustrated by the following examples. It is to be understood that the particular examples, materials, amounts, and procedures are to be interpreted broadly in accordance with the scope and spirit of the invention as set forth herein.

### EXAMPLES

This Example demonstrates the use of a lipidic cubic phase (LCP) as a medium for resolving polypeptides as single bands in electrophoresis.

Preparation of Capillary Tubes Containing the LCP

Monoolein was purchased from Nu-Chek Prep, Incorporated (Elysian, Minn.). The appropriate amount of monoolein was measured out and mixed with 1×native running buffer to form a monoolein/running buffer mixture. For instance, when the LCP was to be 60%(weight/volume) monoolein, 60 micrograms (mg) monoolein was added to 40 microliters (μl) 1×native running buffer (a density of 1 gram/milliliter (g/ml) for solutions was assumed). 1×native running buffer is 240 mM Tris-Cl (pH 8.3) (Mallinckrodt, Hazelwood, Mo., lot number 1806-NO7616,) and 2 M glycine (Sigma, St. Louis, Mo., lot number 10K0269).

An equal volume of monoolein/running buffer mixture and 1×native running buffer (50/50%) were measured out and placed in separate syringes. The two syringes were joined together by a “mixer” and mixed together until the mixture became transparent. Such a mixer is described in Cheng et al., (Chem. Phys. Lipids, 95, 11-21 (1998)). The change from solution to a transparent semi-solid indicated the mixture had become an LCP. The amount of time required to mix the two components together until transparent was about 5 minutes to about 10 minutes. All mixing procedures were performed at 20° C. A four inch needle was attached to the syringe containing the LCP for dispensing into capillary tubes having a diameter of 1.5 mm (Hamilton Company, Reno Nev., Catalog number 0160820 (point style 3).

All of the tubes were plugged at one end with a 12% polyacrylamide gel. The lipidic cubic phase was then applied on top of the plug. The long needle was placed at the bottom of the tube and the LCP was transferred into the tube starting from the bottom and pulling the needle out as transferred the tube was filled with the LCP.

Preparing the Proteins to Load and Electrophoresis

Three proteins were used, rhodamine labeled bovine serum albumin (BSA), myoglobin, and cytochrome C. The proteins were obtained from Sigma (St. Louis, Mo.). The BSA was labeled using a rhodamine labeling kit available form Molecular Probes (Eugene, Oreg.). These three proteins can be detected by visual observation due to intrinsic properties (myoglobin and cytochrome C) or by virtue of the rhodamine label (BSA); however, these proteins cannot be detected in this way when they are denatured. The myoglobin and cytochrome c concentration was 2 mg/ml, and the concentration of the BSA was 5 mg/ml. The buffer was a 1×native running buffer. The proteins were loaded in two different ways. Equal amounts of protein were mixed with 20% glycerol, and 1-2 μl of the protein/glycerol mixture was loaded per lane. The other method for loading protein was to mix the protein with an equal amount of monoolein as stated above and then 1-2 ul of lipid cubic phase was loaded per lane.

The upper and lower buffer in the electrophoresis apparatus was the 1×native running buffer. The experiment was performed at 10° C. by applying 285 volts for 8 hours.

The proteins migrated toward the anode according to their charge and molecular weight. At the end of 8 hours, the proteins were detectable by visual observation. The presence of proteins that were observable in this way strongly suggests that the resolution of the proteins in an LCP did not cause the denaturation of the proteins.

The complete disclosure of all patents, patent applications, and publications, and electronically available material (e.g., GenBank amino acid and nucleotide sequence submissions) cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

All headings are for the convenience of the reader and should not be used to limit the meaning of the text that follows the heading, unless so specified.

What is claimed is:

1. A method for separating a compound, the method comprising:
contacting a mixture of at least two compounds with a bicontinuous lipidic cubic phase; and
applying an external field for a period of time sufficient to result in sufficient movement of the compounds relative to each other such that a compound is separated from the mixture.

2. The method of claim 1 wherein the compound that is separated comprises a biological compound.

3. The method of claim 1 wherein the compound that is separated comprises a membrane polypeptide.

4. The method of claim 1 wherein the mixture of at least two compounds is obtained from a biological entity.

5. The method of claim 1 wherein the external field is an electrical gradient selected from the group consisting of current and voltage.

6. The method of claim 1 wherein the mixture of at least two compounds comprises a detergent.

7. The method of claim 6 wherein the mixture of at least two compounds does not comprise a detergent.

8. The method of claim 1 wherein the lipidic cubic phase comprises a monoacylglycerol.

9. The method of claim 8 wherein the monoacylglycerol is selected from the group consisting of monoolein, monovaccenin, monopentadecenoin, monomyristolein, monoelaidin, monopalmitolein, and monoerucin.

10. The method of claim 9 wherein the monoacylglycerol is monoolein.

11. The method of claim 1 wherein the lipidic cubic phase does not comprise a detergent before contacting.

12. The method of claim 1 wherein the lipidic cubic phase comprises a detergent.

13. The method of claim 12 wherein the detergent is present before contacting.

14. The method of claim 12 wherein the detergent is present as a result of migration of the detergent after applying an external field.

15. The method of claim 1 wherein the compound is isolated.

16. The method of claim 15 wherein the compound is purified.

17. The method of claim 1 further comprising removing the compound from the lipidic cubic phase.

18. A method for separating a compound, the method comprising:
contacting a mixture of at least two compounds with a bicontinuous lipidic cubic phase; and
applying an external field for a period of time sufficient to result in sufficient movement of the compounds relative to each other such that a compound is separated from the mixture, wherein the compound that is separated comprises a membrane polypeptide.

19. A method for separating a compound, the method comprising:
contacting a mixture of at least two compounds with a bicontinuous lipidic cubic phase comprising a monoacylglycerol; and
applying an external field for a period of time sufficient to result in sufficient movement of the compounds relative to each other such that a compound is separated from the mixture.

20. A method for separating a compound, the method comprising:
contacting a mixture of at least two compounds with a bicontinuous lipidic cubic phase comprising a monoacylglycerol; and
applying an external field for a period of time sufficient to result in sufficient movement of the compounds relative to each other such that a compound is separated from the mixture, wherein the compound that is separated comprises a membrane polypeptide.

21. A method for separating a compound, the method comprising:
contacting a mixture of at least two compounds with a bicontinuous lipidic cubic phase comprising monoolein; and
applying an external field for a period of time sufficient to result in sufficient movement of the compounds relative to each other such that a compound is separated from the mixture.

22. A method for separating a compound, the method comprising:
contacting a mixture of at least two compounds with a bicontinuous lipidic cubic phase comprising monoolein; and
applying an external field for a period of time sufficient to result in sufficient movement of the compounds relative to each other such that a compound is separated from the mixture, wherein the compound that is separated comprises a membrane polypeptide.

23. A method for separating a compound, the method comprising:
contacting a mixture of at least two compounds with a bicontinuous lipidic cubic phase, wherein the mixture of at least two compounds does not comprise a detergent; and
applying an external field for a period of time sufficient to result in sufficient movement of the compounds relative to each other such that a compound is separated from the mixture, wherein the compound that is separated comprises a membrane polypeptide.

24. A method for separating a compound, the method comprising:
contacting a mixture of at least two compounds with a bicontinuous lipidic cubic phase comprising monoolein, wherein the mixture of at least two compounds does not comprise a detergent and the bicontinuous lipidic cubic phase does not comprise a detergent; and
applying an external field for a period of time sufficient to result in sufficient movement of the compounds relative to each other such that a compound is separated from the mixture, wherein the compound that is separated comprises a membrane polypeptide.

25. A kit for use in separating a compound, the kit comprising a mixture comprising a lipid and an aqueous phase and instructions for using the mixture, wherein the mixture will form a bicontinuous lipidic cubic phase under specific conditions.

26. The kit of claim 25 further comprising a device suitable for use in an electrophoresis apparatus.

27. The kit of claim 26 wherein the device is selected from the group consisting of a capillary tube or a plate.

28. The kit of claim 25 wherein the lipid is a monoacylglycerol.

29. The kit of claim 28 wherein the monoacylglycerol is selected from the group consisting of monoolein, monovaccenin, monopentadecenoin, monomyristolein, monoelaidin, monopalmitolein, and monoerucin.

30. The method of claim 29 wherein the monoacylglycerol is monoolein.

31. A capillary tube comprising a bicontinuous lipidic cubic phase.

32. An electrophoresis apparatus comprising a bicontinuous lipidic cubic phase.
